(19) United States
(12) Patent Application Publication
(10) Pub. No.: US 2006/0036344 A1
(43) Pub. Date: Feb. 16, 2006

(54) System and method for generating service bulletins based on machine performance data

(75) Inventors: Juan Liu, Milpitas, CA (US); Patrick C. Cheung, Castro Valley, CA (US); Tracy E. Thieret, Webster, NY (US)

Correspondence Address: PATENT DOCUMENTATION CENTER, XEROX CORPORATION, 100 CLINTON AVENUE SOUTH, XEROX SQ. 20 TH FLOOR, ROCHESTER, NY, 14644, US

(73) Assignee: Palo Alto Research Center Incorporated

(21) Appl. No.: 10/915,813

(22) Filed: Aug. 11, 2004

(51) Int. Cl. G06F 19/00

(52) U.S. Cl. 700/96; 702/184

(57) ABSTRACT

A computer-implemented method collects operational state and usage data from a population of networked machines in communication with a service center for the purpose of adjusting service schedules. The method includes applying domain knowledge to develop one or more hypotheses defining a correlation between usage/environment and the operational health of the machine(s). The method gathers usage data from the machines, deletes unrelated usage data at a preprocessing stage, and identifies suitable data mining tasks and techniques for analysis of the data. Data mining tools are applied to discover knowledge pertaining to the one or more hypotheses. Discovered knowledge is interpreted and a determination is made on whether to refine the one or more hypotheses. When a determination is made not to continue refining the one or more hypotheses, the manufacturer's service schedule is adjusted and feedback is provided to the machine population.

### INCORPORATION BY REFERENCE

The following U.S. patents are fully incorporated herein by reference: U.S. Pat. No. 6,606,527 (“Methods and Systems for Planning Operations in Manufacturing Plants”); U.S. Pat. No. 6,594,028 (“Status-based Control Over Printer”); and U.S. Pat. Pub. No. 20020073012 A1 (“Vehicle Service Repair Network”).

### BACKGROUND

This disclosure relates generally to the generation of maintenance schedules for a population of machines. More specifically, the disclosure relates to the generation of service bulletins based on continuously analyzed machine data.

The complexity of machines such as copiers, automobiles, and military equipment, and the speed with which they are manufactured create several problems associated with maintenance. First, many instances of the machine are manufactured and deployed before a problem in the design or manufacturing process is discovered. Second, identifying the existence of a problem, its source, and the machines that are affected is difficult because of variations in the manufacturing process, such as a change in the supplier of a subcomponent, and distribution of the machines internationally. Finally, variations in the environment or workloads where the machines are used may cause or mask failures.

Currently, a maintenance schedule is often provided by the manufacturer when machines are released into the market. The manufacturer decides on the schedule based on knowledge about the design of the machine. The schedule is homogeneous across a large population of machines and remains fixed throughout the lifetime of the machine. Such a maintenance strategy, based on design knowledge alone, is often very conservative and fails to take advantage of customer feedback. As a result, it is often inefficient.

In practice, however, some tuning of maintenance strategy has been used. For example, car manufacturers may suggest different maintenance schedules for cars driving in cold weather conditions as compared with cars driving in warm weather conditions. Service people may also move the maintenance date forward or backwards based on their knowledge and customer feedback/complaints. But these tuning methods are very crude and mostly based on limited knowledge about local machines. Such knowledge is incomplete and may be unreliable. A process is needed for finding performance problems in a subset of a large fleet of machines, determining the cause of the problem, determining which other machines may be affected, and distributing appropriate remedies.

### BRIEF SUMMARY

The disclosed embodiments provide examples of improved solutions to the problems noted in the above Background discussion and the art cited therein. There is shown in these examples an improved computer-implemented method for collecting operational state and usage data from networked machines in communication with a service center for the purposes of adjusting service schedules. The method assesses the diagnostic/prognostic states of the networked machines and adjusts machine maintenance schedules. The method includes applying domain knowledge to develop one or more hypotheses defining a correlation between usage/environment and the operational health of the machine(s). The method gathers usage data from the machines, deletes unrelated usage data at a preprocessing stage, and identifies suitable data mining tasks and techniques for analysis of the data. Data mining tools are applied to discover knowledge pertaining to the one or more hypotheses. Discovered knowledge is interpreted and a determination is made on whether to refine the one or more hypotheses. When a determination is made not to continue refining the one or more hypotheses, the manufacturer's service schedule is adjusted and feedback is provided to the machine population.

In another embodiment, there is described a computer implemented system for collecting operational state and usage data from a population of networked machines and assessing the diagnostics/prognostic states of the networked machines and their components to adjust machine maintenance schedules. The networked machines are in communication with a service center and with a processor within the computer system. The system includes means for applying domain knowledge to develop one or more hypotheses defining a correlation between usage/environment of one or more machines and the operational health of the machines. The system gathers usage data from the population of machines, deletes unrelated usage data at a preprocessing stage, and identifies suitable data mining tasks and techniques for analysis of the usage data. Data mining tools are applied to discover knowledge pertaining to the one or more hypotheses, the discovered knowledge is interpreted, and a determination is made as to whether to refine the developed hypothesis(es). This process is repeated until a determination is made not to continue refining the one or more hypotheses. The manufacturer's service schedule is adjusted based on data mining results, and feedback is provided to the machine population.

In yet another embodiment, there is disclosed an article of manufacture comprising a computer usable medium having computer readable program code embodied in the medium which causes the computer to perform method steps for adjusting machine maintenance schedules a population of networked machines within a computer controlled production system. The networked machines are in communication with a service center. The method includes applying domain knowledge to develop one or more hypotheses defining a correlation between usage/environment of a machine(s) and the operational health of the machine(s). Usage data is gathered from the population of machines, unrelated usage data is deleted at a preprocessing stage, and suitable data mining tasks and techniques are identified for analysis of the usage data. Data mining tools are applied to discover knowledge pertaining to one or more hypotheses. The discovered knowledge is interpreted, and a determination is made as to whether to refine one or more hypotheses. This process is repeated until a determination is made not to continuing to refine one or more hypotheses. The manufacturer's service schedule is adjusted based on data mining results, and feedback is provided to the machine population.

### BRIEF DESCRIPTION OF THE DRAWINGS

The foregoing and other features of the embodiments described herein will be apparent and easily understood from a further reading of the specification, claims and by reference to the accompanying drawings in which:

FIG. 1 is a diagram illustrating customization of maintenance policies through utilization of usage data;

FIG. 2 is an example embodiment of a print system utilizing machine performance/usage data to customize maintenance policies;

FIG. 3 is an example embodiment of a maintenance scheduling system for a fleet of printers;

FIG. 4 is a flow chart for one embodiment of the method for generating maintenance schedules based on performance data; and

FIG. 5 is a diagram illustrating combination of local usage data and population knowledge for the customization of maintenance policies.

### DETAILED DESCRIPTION

The method and system disclosed herein utilizes data-mining techniques in the generation and adjustment of service bulletins. The method and system take advantage of a large volume, constant stream of data (usage feedback data) being received from a fleet of machines to optimize the efficiency of service schedules through customization based on usage and environment. The use of diagnostic and data mining techniques produces more reliable and optimal results than tuning based on customer complaints and/or technician experience. The resulting maintenance schedule is adaptive, using performance data to acquire knowledge about occurrences of failure and continuously adapting this knowledge to individual machines, which reduces service costs and reduces or prevents machine failure.

The system and method apply to control software used for multi-step production processes such as manufacturing, printing, or assembly and provide for the handling of complex operations over complex paths to provide maintenance schedules based on machine performance/usage data. In the following description numerous specific details are set forth in order to provide a thorough understanding of the system and method. It would be apparent, however, to one skilled in the art to practice the system and method without such specific details. In other instances, specific implementation details have not been shown in detail in order not to unnecessarily obscure the present invention.

Various computing environments may incorporate capabilities to provide maintenance schedules based on machine performance/usage data. The following discussion is intended to provide a brief, general description of suitable computing environments in which the method and system may be implemented. Although not required, the method and system will be described in the general context of computer-executable instructions, such as program modules, being executed by a single computer. Generally, program modules include routines, programs, objects, components, data structures, etc., that perform particular tasks or implement particular abstract data types. Moreover, those skilled in the art will appreciate that the method and system may be practiced with other computer system configurations, including hand-held devices, multi-processor systems, microprocessor-based or programmable consumer electronics, networked PCs, minicomputers, mainframe computers, and the like.

The method and system may also be practiced in distributed computing environments where tasks are performed by remote processing devices that are linked through a communications network. In a distributed computing environment, program modules may be located in both local and remote memory storage devices. Although the method and system described herein is not limited to embedded applications, the following discussion will pertain to embedded systems for purposes of example only. One skilled in the art will appreciate that the provision of maintenance schedules based on machine performance/usage data is useful for many complex control problems and generic software solutions to a wide variety of machine control problems, among others. Additionally, it may be practiced in a multitude of computing environments.

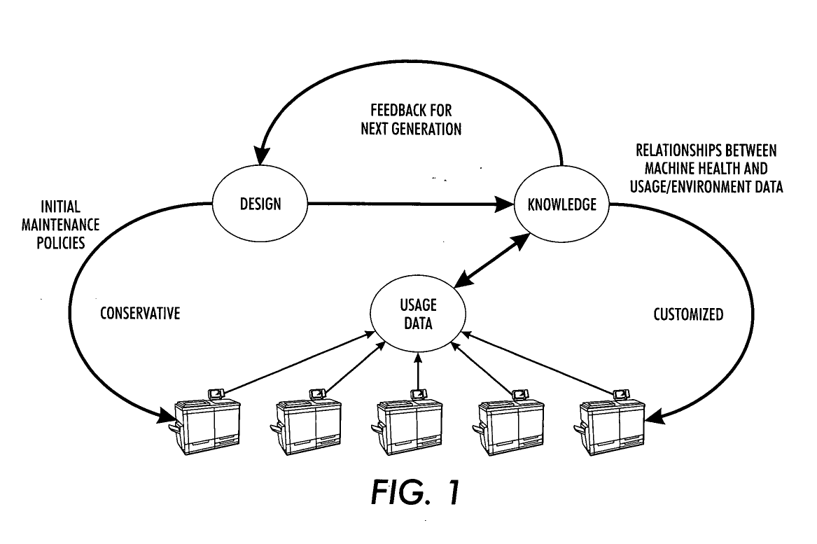

Turning now to FIG. 1, the diagram illustrates customization of maintenance policies through utilization of usage data. In existing systems, the manufacturer provides a maintenance policy based on the design of a machine. These policies (initial maintenance policies, as illustrated in FIG. 1) are often conservative and inefficient. The system and method disclosed herein is directed to those machines, such as printers, that are designed to produce streams of data regarding machine usage and environmental settings on a regular basis (e.g., daily) to service centers through telephone lines or the internet. This data may be continuously collected from a large population of machines and is distilled to provide not only a reference for future design, but also to optimally customize maintenance policies.

For the purposes of maintenance policy adjustment, the data correlation between machine health and the usage/environment are particularly useful. For example, usage data for a particular of printer may show that fuser modules of machines printing out mostly long jobs tend to have higher print count in its lifetime than the fuser modules of machines printing out mostly short jobs (possibly due to fuser module heating and cooling cycling). Such a finding can be used to adjust the replacement schedule for fuser modules. Another example is that users have noticed that printers operating in non-air conditioned humid weather tend to jam more frequently than printers operating in dry conditions.

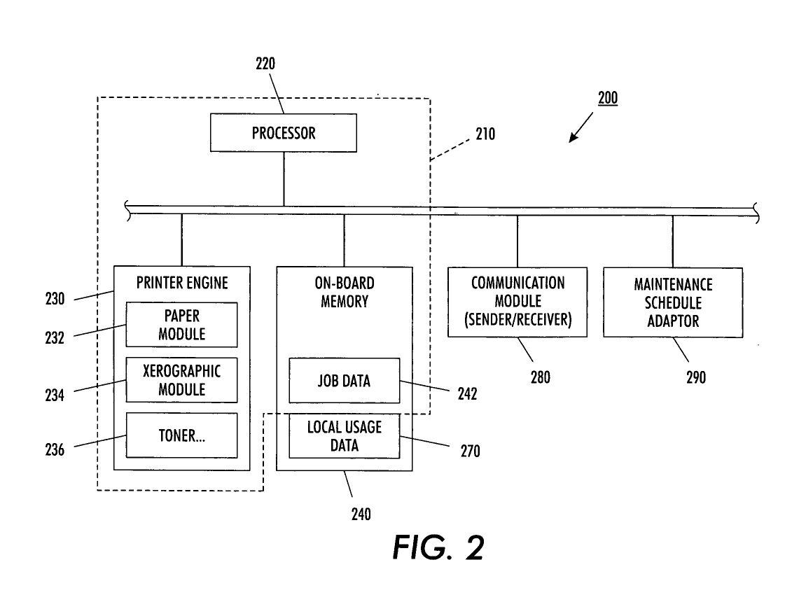

Turning now to FIG. 2, there is illustrated one embodiment of an example system for utilizing the collection of performance data to customize maintenance policies. Although, for the purposes of descriptive discussion, the following embodiments are presented within the context of a printer system, it is noted that the system and method herein disclosed may be beneficially employed in any of numerous fleets of machines, where usage data can be continuously and regularly collected at a central place such as a database or service center. Examples of such machine fleets include copiers, networked equipment, and military equipment, among others. Utilization of the system and method herein in all such applications is fully contemplated by the specification and scope of the claims herein. In this example embodiment, printer 200 includes a processor 220, which provides user interface capability, control of printer operation, and necessary data processing. Printer engine 230 includes paper module 232, xerographic module 234, toner module 236, as well as various other known modules utilized during print production. On-board memory 240 includes job data module 242 and local usage data module 270. Job data module 242 temporally buffers data to be printed (e.g., in the format of a postscript file), and local usage data module 270 stores meta-information about the job, such as the number of pages, double or single-sided, the percentage of figures and texts, etc. Also included in the printer and in communication with processor 220 is communication module 280, which sends a summary of machine usage data (stored in the local usage data module 270) over a pre-specified interval of time (e.g., 24 hours) to the service center on a regular basis (e.g., daily). It also has a receiver which can regularly receive maintenance suggestions broadcast from the service center. Maintenance schedule adaptor 290 stores the maintenance suggestions received by the communication module, and compares these suggestions with local usage data. It adjusts the maintenance schedules accordingly. The finalized adapted schedule is then sent to the processor module 220, where the schedule is executed.

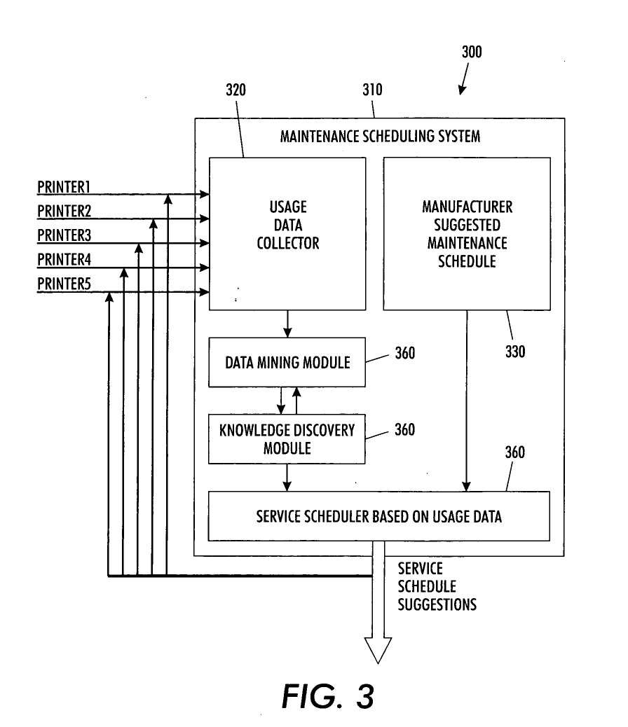

Referring now to FIG. 3, there is illustrated the maintenance scheduling system based on usage data collected from a fleet of printers. Here the fleet of printers provides data on a continuous basis to maintenance scheduling system 310. Usage data collector 320 receives data from the fleet of printers and preprocesses the data to remove unrelated entries. Data mining module 340 identifies data mining tasks, and applies suitable data mining tools to the collected, preprocessed data. These results are provided to knowledge discovery module 350, which determines whether the information gleaned from data mining is aligned with the original hypothesis associated with the correlation between machine health and usage/environment developed in the data mining module 340. A determination is made as to whether to refine the process by returning to data mining module 340 to discover additional support or evidence for the data mining hypothesis, or if the hypothesis is discounted, to identify a new possible hypothesis. There may be a few rounds of interaction between the data mining module 340 and the knowledge discovery module 350 to reach a reliable knowledge summarization. After an underlying correlation has been revealed, for example, there is negative correlation between the percentage of double-sided printing and the life expectancy of paper module, the information is passed to service scheduler 360, which also receives information on the manufacturer's suggested maintenance schedule from module 330. Module 360 makes adjustments based on the manufacturer's suggestions and the knowledge obtained from data mining, then formulates service schedule suggestions to be transmitted to the fleet of printers. The scheduling adjustment can be done using a statistical fusion approach or a rule-based reasoning approach.

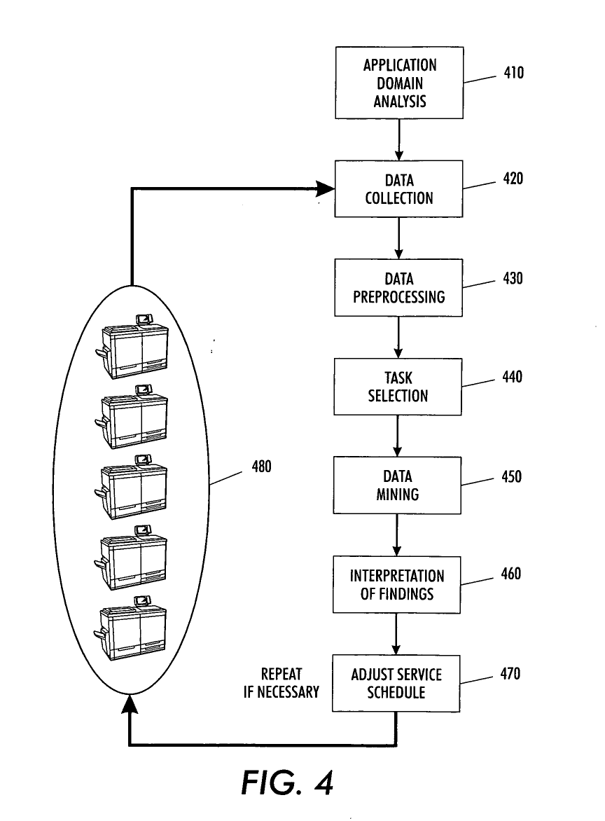

Turning now to FIG. 4, data mining techniques are utilized for hypothesizing and verifying data correlation iteratively and incrementally. At 410 domain knowledge, based on design and experience, is applied to hypothesize at least one correlation between usage/environment and machine health. In general, a hypothesis can be any statement regarding machine usage and machine health. For example, based on the usage data, one may suspect that printers printing mostly double-sided print jobs may have more paper jams than printers printing mostly single-sided jobs. To verify or disprove the hypothesis, at 420 data is gathered from the population of machines 480 and unrelated data (for example, data concerning no entries about double or single-sided printing) is deleted at the pre-processing stage 430. Suitable data mining tasks (clustering, correlation, classification, etc) and techniques are identified at 440.

Using data mining tools at 450, it is possible to discover knowledge which may or may not be well aligned with the original hypothesis. Data mining tools include, for example, statistical analysis, clustering, and associations. Statistical analysis examines the low order statistics of the data (e.g., how many printed pages are in color or in greyscale). Clustering is directed to discovering the internal structure of the data. For example, in a financial mortgage firm, job length measured in the number of pages may be uni-modal, if the jobs are mostly in the same format. Or the job length can come in two clusters, the shorter cluster corresponds to application forms (normally only a few pages), and the longer cluster corresponds to closing/escrow documents (normally a hundred pages). Association aims at discovering the correlation between two entities, such as associating the shortened life expectancy of a paper module with excessive use of double-sided printing At 460 the findings are interpreted and the user may choose to refine the hypothesis and repeat the process, beginning at 410. The service schedule is adjusted at 470 based on the data mining results and feedback is provided to the machine population 480. The adjustment 470 may move the scheduled maintenance (as suggested by the original manufacturer) forward or backward. For example, if the hypothesis that double-sided printing shortens the life of the paper module is verified, and the fleet of printers performs frequent double-sided printing, then the adjustment module will recommend increasing the frequency of paper module maintenance. The method can be as simple as a straight-forward Bayesian fusion, or it can be more complicated statistical methods. The adjusted maintenance schedule is then fed back to the printer fleet, and additional knowledge/adjustment can be identified or made if necessary. Each machine uses the population knowledge as a reference, and combines the population knowledge with its local knowledge to customize its maintenance schedule.

As can be seen from the discussion above, machine data is analyzed on a continuous basis. Since data is streaming in regularly, it is possible to continually monitor the correlation between incoming data and machine health, which is in contrast to current practice in industry. For example, in the automotive industry, individual cars do not continuously transmit data to car manufacturers. Rather, data is collected very sparsely: for example, twice a year during regular maintenance, or from user complaints or machine failures. Sparse data cannot enable continuous monitoring, and user complaints and failures often occur after a machine fault incident, which may be too late for the purposes of adjusting maintenance schedules.

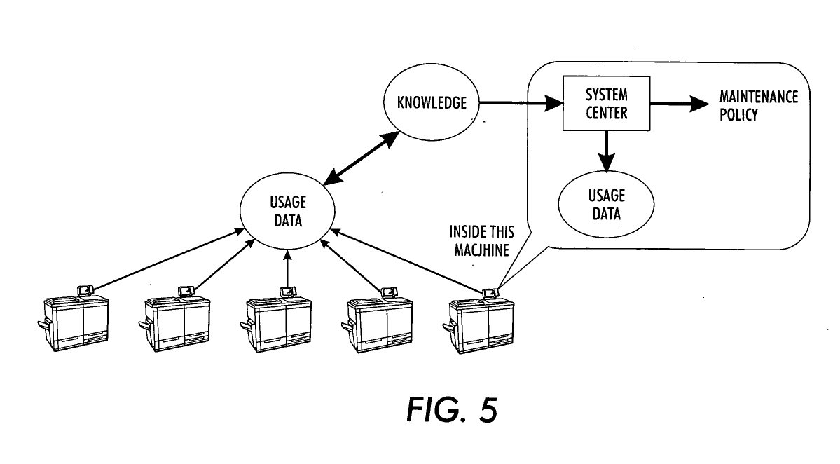

Utilization of the population knowledge as a reference combined with the individual machine's local knowledge is illustrated in FIG. 5. The fusion center assesses the cost and benefit of a set of feasible maintenance actions and optimally selects one based on the population knowledge and the local usage. A simple form of this is categorization of the entire population into several categories (such as light, medium, or heavy wear) and assessment as to which group each machine is most closely associated. The appropriate maintenance policy is then selected accordingly. Alternatively, Bayesian analysis may be applied, treating population knowledge as models (a priori knowledge) and local usage as observations.

While the present discussion has been illustrated and described with reference to specific embodiments, further modification and improvements will occur to those skilled in the art. Additionally, “code” as used herein, or “program” as used herein, is any plurality of binary values or any executable, interpreted or compiled code which can be used by a computer or execution device to perform a task. This code or program can be written in any one of several known computer languages. A “computer”, as used herein, can mean any device which stores, processes, routes, manipulates, or performs like operation on data. It is to be understood, therefore, that this disclosure is not limited to the particular forms illustrated and that it is intended in the appended claims to embrace all alternatives, modifications, and variations which do not depart from the spirit and scope of the embodiments described herein.

What is claimed:

1. A method implemented on a computer system for collecting operational state and usage data from a plurality of networked machines and assessing the diagnostics/prognostic states of the networked machines and their components for adjusting machine maintenance schedules for at least one machine within the plurality of networked machines within a computer controlled production system, wherein the networked machines are in communication with a service center and with a processor within the computer system, each of the machines within the population of machines having a manufacturer's suggested service schedule, the method comprising:
applying domain knowledge to develop at least one hypothesis defining a correlation between usage/environment of at least one machine of the population of machines and the operational health of said at least one machine;
gathering usage data from the population of machines;
deleting unrelated usage data at a preprocessing stage;
identifying suitable data mining tasks and techniques for analysis of said usage data;
applying data mining tools to discover knowledge pertaining to said hypothesis;
interpreting said discovered knowledge;
determining whether to refine said hypothesis;
repeating applying domain knowledge to develop a revised hypothesis, gathering usage data, deleting unrelated usage data, identifying suitable data mining tasks, applying data mining tools to discover knowledge pertaining to said revised hypothesis, and interpreting said discovered knowledge, and determining whether to refine said hypothesis until a determination is made not to continuing to refine said hypothesis;
adjusting the manufacturer's service schedule based on data mining results; and
providing feedback to the machine population.

2. The method for collecting operational state and usage data from a plurality of networked devices and assessing the diagnostics/prognostic states of the networked devices and their components for adjusting maintenance schedules for the plurality of networked devices according to claim 1, wherein said data mining tools comprise at least one member selected from the group consisting of statistical analysis, clustering, and associations.

3. The method for collecting operational state and usage data from a plurality of networked devices and assessing the diagnostics/prognostic states of the networked devices and their components for adjusting maintenance schedules for the plurality of networked devices according to claim 2, wherein said statistical analysis examines the low order statistics of said usage data.

4. The method for collecting operational state and usage data from a plurality of networked devices and assessing the diagnostics/prognostic states of the networked devices and their components for adjusting maintenance schedules for the plurality of networked devices according to claim 2, wherein said clustering discovers internal structure of said usage data.

5. The method for collecting operational state and usage data from a plurality of networked devices and assessing the diagnostics/prognostic states of the networked devices and their components for adjusting maintenance schedules for the plurality of networked devices according to claim 2, wherein association includes correlation between two entities.

6. The method for collecting operational state and usage data from a plurality of networked devices and assessing the diagnostics/prognostic states of the networked devices and their components for adjusting maintenance schedules for the plurality of networked devices according to claim 1, wherein adjusting said manufacturer's service schedule comprises utilization of at least one member selected from the group consisting of Bayesian fusion and statistical methods.

7. The method for collecting operational state and usage data from a plurality of networked devices and assessing the diagnostics/prognostic states of the networked devices and their components for adjusting maintenance schedules for the plurality of networked devices according to claim 1, wherein said data mining tasks comprise at least one member selected from the group consisting of clustering, correlation, and classification.

8. The method for collecting operational state and usage data from a plurality of networked devices and assessing the diagnostics/prognostic states of the networked devices and their components for adjusting maintenance schedules for the plurality of networked devices according to claim 1, wherein said usage data is continuously gathered during operation of the networked machines.

9. The method for collecting operational state and usage data from a plurality of networked devices and assessing the diagnostics/prognostic states of the networked devices and their components for adjusting maintenance schedules for the plurality of networked devices according to claim 1, wherein said usage data is gathered at least once per day from the networked machines.

10. A computer implemented system for collecting operational state and usage data from a plurality of networked machines and assessing the diagnostics/prognostic states of the networked machines and their components for adjusting machine maintenance schedules for at least one machine within the plurality of networked machines within a computer controlled production system, wherein the networked machines are in communication with a service center and with a processor within the computer system, each of the machines within the population of machines having a manufacturer's suggested service schedule, the system comprising:
means for applying domain knowledge to develop at least one hypothesis defining a correlation between usage/environment of at least one machine of the population of machines and the operational health of said at least one machine;
means for gathering usage data from the population of machines;
means for deleting unrelated usage data at a preprocessing stage;
means for identifying suitable data mining tasks and techniques for analysis of said usage data;
means for applying data mining tools to discover knowledge pertaining to said hypothesis;
means for interpreting said discovered knowledge;
means for determining whether to refine said hypothesis;
means for repeating applying domain knowledge to develop a revised hypothesis, gathering usage data, deleting unrelated usage data, identifying suitable data mining tasks, applying data mining tools to discover knowledge pertaining to said revised hypothesis, and interpreting said discovered knowledge, and determining whether to refine said hypothesis until a determination is made not to continuing to refine said hypothesis;
means for adjusting the manufacturer's service schedule based on data mining results; and
means for providing feedback to the machine population.

11. The computer implemented system for collecting operational state and usage data from a plurality of networked devices and assessing the diagnostics/prognostic states of the networked devices and their components for adjusting maintenance schedules for the plurality of networked devices according to claim 10, wherein said data mining tools comprise at least one member selected from the group consisting of statistical analysis, clustering, and associations.

12. The computer implemented system for collecting operational state and usage data from a plurality of networked devices and assessing the diagnostics/prognostic states of the networked devices and their components for adjusting maintenance schedules for the plurality of networked devices according to claim 11, wherein said statistical analysis examines the low order statistics of said usage data.

13. The computer implemented system for collecting operational state and usage data from a plurality of networked devices and assessing the diagnostics/prognostic states of the networked devices and their components for adjusting maintenance schedules for the plurality of networked devices according to claim 11, wherein said clustering discovers internal structure of said usage data.

14. The computer implemented system for collecting operational state and usage data from a plurality of networked devices and assessing the diagnostics/prognostic states of the networked devices and their components for adjusting maintenance schedules for the plurality of networked devices according to claim 11, wherein association includes correlation between two entities.

15. The computer implemented system for collecting operational state and usage data from a plurality of networked devices and assessing the diagnostics/prognostic states of the networked devices and their components for adjusting maintenance schedules for the plurality of networked devices according to claim 10, wherein adjusting said manufacturer's service schedule comprises utilization of at least one member selected from the group consisting of Bayesian fusion and statistical methods.

16. The computer implemented system for collecting operational state and usage data from a plurality of networked devices and assessing the diagnostics/prognostic states of the networked devices and their components for adjusting maintenance schedules for the plurality of networked devices according to claim 10, wherein said data mining tasks comprise at least one member selected from the group consisting of clustering, correlation, and classification.

17. The computer implemented system for collecting operational state and usage data from a plurality of networked devices and assessing the diagnostics/prognostic states of the networked devices and their components for adjusting maintenance schedules for the plurality of networked devices according to claim 10, wherein said usage data is continuously gathered during operation of the networked machines.

18. The computer implemented system for collecting operational state and usage data from a plurality of networked devices and assessing the diagnostics/prognostic states of the networked devices and their components for adjusting maintenance schedules for the plurality of networked devices according to claim 10, wherein said usage data is gathered at least once per day from the networked machines.

19. An article of manufacture comprising a computer usable medium having computer readable program code embodied in said medium which, when said program code is executed by said computer causes said computer to perform method steps for adjusting machine maintenance schedules for at least one machine within a plurality of networked machines within a computer controlled production system, wherein the networked machines are in communication with a service center, each of the machines having a manufacturer's suggested service schedule, method comprising:
applying domain knowledge to develop at least one hypothesis defining a correlation between usage/environment of at least one machine of the population of machines and the operational health of said at least one machine;
gathering usage data from the population of machines;
deleting unrelated usage data at a preprocessing stage;
identifying suitable data mining tasks and techniques for analysis of said usage data;
applying data mining tools to discover knowledge pertaining to said hypothesis;
interpreting said discovered knowledge;
determining whether to refine said hypothesis;
repeating applying domain knowledge to develop a revised hypothesis, gathering usage data, deleting unrelated usage data, identifying suitable data mining tasks, applying data mining tools to discover knowledge pertaining to said revised hypothesis, and interpreting said discovered knowledge, and determining whether to refine said hypothesis until a determination is made not to continuing to refine said hypothesis;
adjusting the manufacturer's service schedule based on data mining results; and
providing feedback to the machine population.
